(19) United States
(12) Patent Application Publication
(10) Pub. No.: US 2002/0095256 A1
(43) Pub. Date: Jul. 18, 2002

(54) Process to graphically display travel information on a map in electronic form

(75) Inventors: Terrell B. Jones, Arlington, TX (US); David C. Browne, Flower Mound, TX (US); Christopher D. Gawronski, North Richland Hills, TX (US)

Correspondence Address: FINNEGAN, HENDERSON, FARABOW, GARRETT &, DUNNER LLP, 1300 I STREET, NW, WASHINGTON, DC, 20005, US

(73) Assignee: Travelocity.com LP

(21) Appl. No.: 09/758,316

(22) Filed: Jan. 12, 2001

(51) Int. Cl. G01C 21/32

(52) U.S. Cl. 701/200; 340/995

(57) ABSTRACT

A system and method for graphically displaying travel information on an electronic map within a network environment comprising: (i) providing a network for transmitting and receiving information among information providers; (ii) receiving an information request based on a flexible set of user-defined travel related criteria; (iii) processing the information request to initiate at least one inquiry based on the information request from a plurality of data tables developed from a database; (iv) receiving at least one response to at least one inquiry; (v) processing at least one response to determine a reply that is responsive to the information request, and (vi) providing a response including an electronic map overlay.

### BACKGROUND OF THE INVENTION

A. Field of the Invention

This invention relates to displaying information in electronic form and, more particularly, to graphically displaying travel information on a map in electronic form in response to a flexible set of user-defined criteria, such as originating city, airfare threshold, weather conditions, points of interest and the like.

B. Description of the Related Art

By using the Internet, and specifically the World Wide Web (“Web”), the ability to interface with business computers is simplified. The architecture of the Web follows a conventional client-server model. The terms “client” and server” are used to refer to a computer's general role as a requester of data (the client) or provider of data (the server). Under the Web environment, Web browsers reside in clients and specially formatted “Web documents” reside on Internet (Web) servers. Web clients and Web servers communicate using a protocol called “HyperText Transfer Protocol” (HTTP).

In operation, a browser opens a data connection to a server and initiates a request for a document. The server delivers the requested document, typically in a form coded in a standard “HyperText Markup Language” (HTML) format. After the document is delivered, the connection is closed and the browser displays the document or performs a function designated by the document.

The Internet is being increasingly used as an avenue for business and commerce, including making travel plans and reservations. Currently when utilizing the Internet for making air travel reservations, customers, through a Web browser, formulate a flight reservation request. This flight reservation request service may be with a particular airline or with a third-party operating with information from one or more airlines. The customer's request typically includes criteria, such as the departure and destination cities, maximum price, and travel dates. The reservation system then determines flights that match the customer's request criteria and typically outputs this solution set (i.e. the flights that satisfy the request criteria), arranged by cost from lowest to highest fare. Fares may differ based on the specified departure and/or destination airports, and some systems have the capability to provide alternative airports for both departure and destination at the user's request.

Although price and flight availability are important considerations when making travel arrangements, the travel decision may be based on or influenced by other factors, such as a business meeting or vacation plan. As a result of these factors, travelers may require additional information associated with the proposed travel arrangements, particularly when they have the option of selecting alternative airports.

Accordingly, there is a need for a system and method that provides information based on a flexible set of user-defined criteria, such as airfares, weather conditions, points of interest, events and the like.

### SUMMARY OF THE INVENTION

Accordingly, methods and systems consistent with the present invention obviate one or more problems of existing systems for determining a reply to a travel information request based on a flexible set of user-defined criteria, such as originating city, airfare threshold, weather conditions, points of interest, events and the like.

In accordance with one aspect of the present invention, as embodied and broadly described herein, a method for graphically displaying travel information on an electronic map within a network environment comprises: (i) receiving an information request based on a flexible set of user-defined travel related criteria; (ii) processing the information request to initiate at least one inquiry based on the information request from a plurality of data tables developed from a database; (iii) receiving at least one response to at least one inquiry; (iv) processing at least one response to determine a reply that is responsive to the information request; and (v) providing a user with a reply including an electronic map overlay.

In the method of the present invention, the flexible set of user-defined travel related criteria received by the network may be input by a user on a personal computer or client, and the user may, at least in part, pre-select the user-defined travel related criteria by topic. The flexible set of user-defined travel related criteria may also be prepackaged by the client to provide for a reply having a predetermined number of output types.

In accordance with another aspect of the invention, as a result of inputting travel-related criteria, at least one inquiry may be directed to a data table selected from a group of data tables consisting of airfare, airfare availability, weather, event, points of interest, and lodging information, to formulate a response.

In accordance with yet another aspect of the invention, as embodied and broadly described herein, a travel information network is provided comprising a request manager for requesting and receiving travel information from information providers, which is stored in a database that is used to develop the data tables for determining a solution set to the travel information request.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 is a pictorial diagram of a computer network in which systems consistent with the present invention may be implemented;

FIG. 2 shows a computer network containing a client system and a server system;

FIG. 3 is a pictorial diagram of a component system used in the manner consistent with an exemplary embodiment of the present invention;

FIG. 4 is a flowchart of the steps performed between a client and a network utilizing the inquiry paradigm in a manner consistent with an exemplary embodiment of the present invention; and

FIG. 5 is an exemplary configuration in which the requested information is graphically illustrated on a map.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

Introduction

Systems and methods consistent with the present invention use a network for distributing information based on a flexible set of user-defined criteria. The network allows users to request the information and to access the results of their request. The network includes one or more servers and data tables that can provide a response to the requested information, as well as other information not specifically requested, such as maps in electronic form.

The network, used in accordance with the principles of the present invention, allows a user to receive a single reply comprising a solution set to an information request. In one embodiment, the information request can be divided into a plurality of sub-requests or inquiries, with the system and method of the present invention providing the users with a single reply to the information requested, thereby providing the user with a one-stop shopping experience.

The single reply can be configured such that the solution set to the requested information is graphically illustrated or overlaid on an electronic map. The electronic map, for example, may identify geographic locations that constitute the solution set and satisfy the requirements specified in the information request.

A user first generates an information request based on a flexible set of user-defined criteria. These criteria may include departure airports, maximum airfares, weather conditions (e.g. temperature and snow base), points of interest, events, hotels, distances between airports and certain geographic locations, and the like. The user-defined criteria may be generated in a variety of ways as further discussed below.

The user's request, based on the flexible set of user-defined criteria, is processed by one or more servers. The result of the processed request provided to the user, through the processing server(s), may be a result of one or more inquiries that collectively comprise some or all of the requested information. The processing server(s) preferably query one or more data tables to provide a response to the request. The processing server(s) process the one or more responses to the query, to determine the solution set that satisfies the information request posed by the user. A reply comprising this solution set is then provided to the user.

Network Architecture

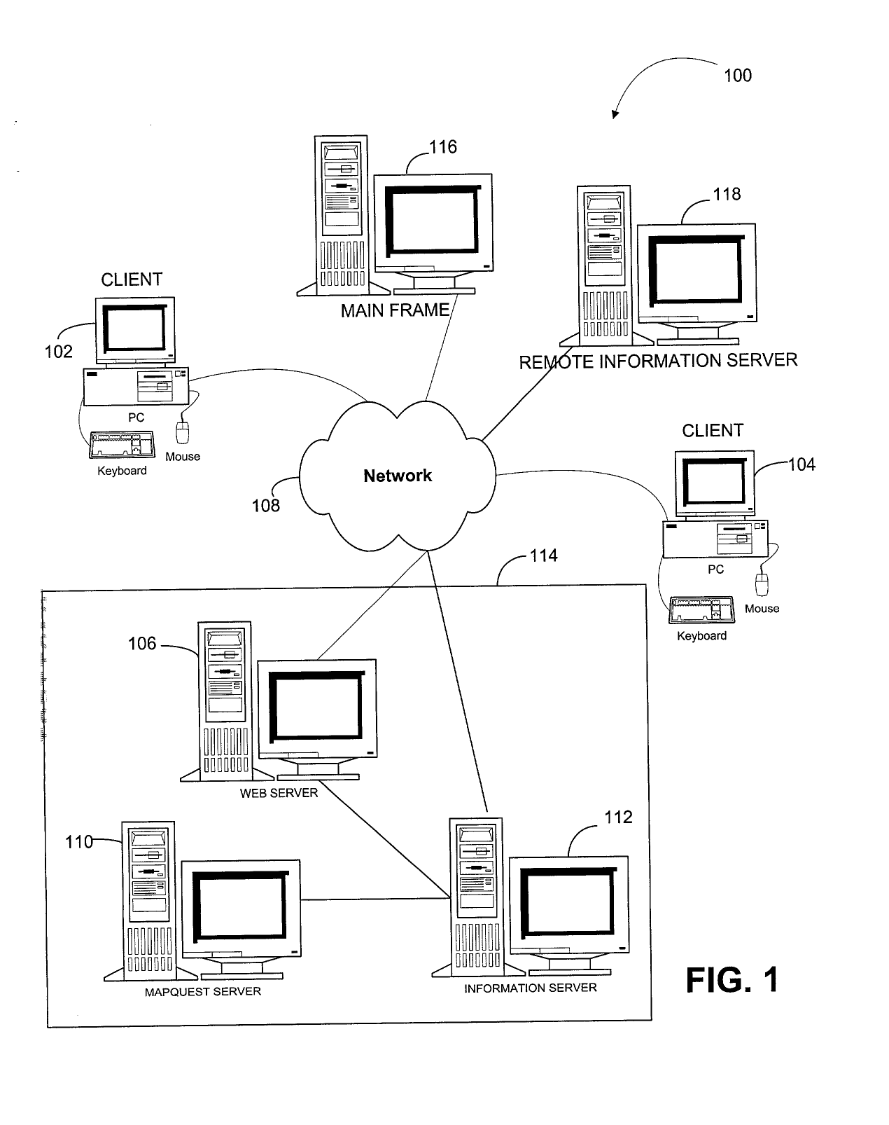

FIG. 1 illustrates a conceptual diagram of a computer network 100 that implements the present invention using a client/server architecture. In FIG. 1, a user's request is sent by an application program running on client 102 and/or client 104 to a web server 106 (typically, the web server is a remote computer system accessible over a network 108, such as the Internet or other communication medium). A client process may be active in client 102 and/or client 104, and a server process may be active in a second computer system 114, and communicate with one another over a communication network 108, thus providing distributed functionality and allowing multiple clients to take advantage of the information gathering capabilities of the computer system 114.

The web server 106, as will be described in more detail below, provides an interface for the user to enter the computer system 114. Within computer system 114, the information server 112 is responsible for retrieving information from various sources, such as mainframe 116 and remote information server 118. In one embodiment, the mainframe 116 may be the SABRE system, which provides users with access to numerous databases of travel information for the purpose of making customer reservations with airlines, hotels, car rental agencies, etc. SABRE is a registered trademark of TSGL Holdings, Inc.

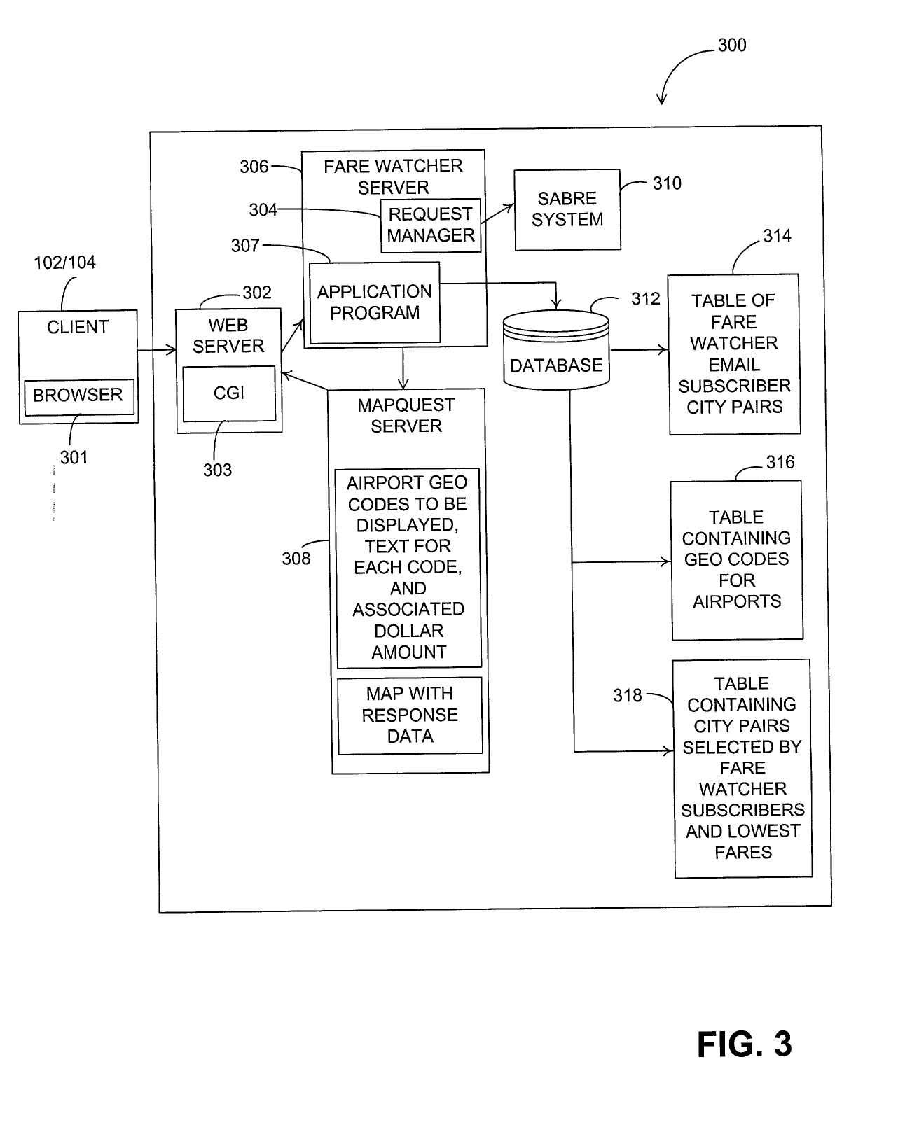

In the embodiment containing the mainframe 116 or in another embodiment, the remote information server 118 may be a weather, event, points of interest, lodging, or any other type of server that can provide information to populate a database maintained within information server 112. The information stored within the database of information server 112 will be described in greater detail in conjunction with FIG. 3.

Based on the information stored in information server 112 and the user's request submitted to the web server 106, the MapQuest server 110 generates a map, including the stored information. The map and the stored information is then passed to the web server 106 for transmission, through the network 108, to the client 102 and/or 104. The client 102 and/or 104, using a browser, displays the map and the stored information to the user. MapQuest is a registered trademark of MapQuest.com.

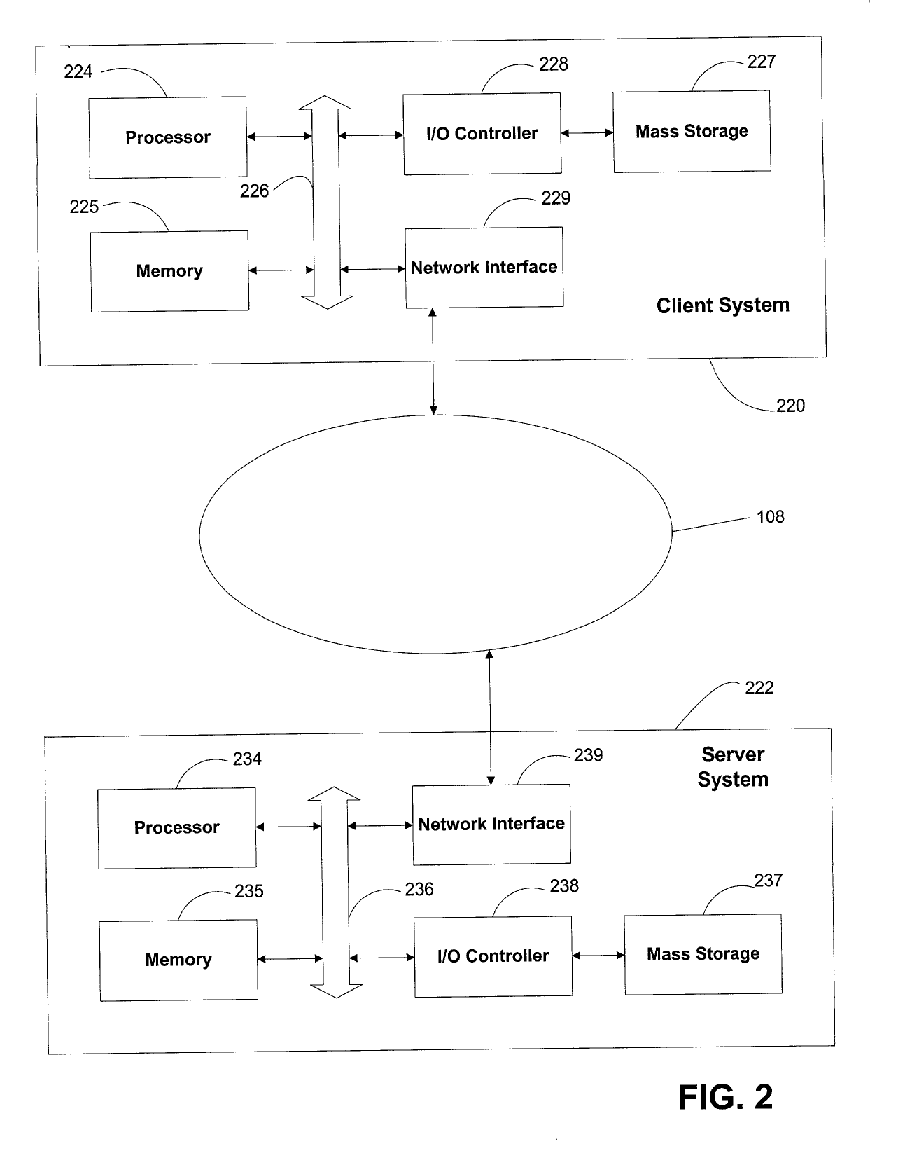

Turning now to FIG. 2, which shows in more detail, an example of a client-server system interconnected through network 108. In this example, a remote server system 222 is interconnected through network 108 to client system 220. Client system 220 includes conventional components such as a processor 224, memory 225 (e.g. RAM), a bus 226 which couples processor 224 and memory 225, a mass storage device 227 (e.g. a magnetic hard disk or an optical storage disk) coupled to processor 224 and memory 225 through an I/O controller 228 and a network interface 229, such as a conventional modem.

Server system 222 also includes conventional components such as a processor 234, memory 235 (e.g. RAM), a bus 236 which couples processor 234 and memory 235, a mass storage device 237 (e.g. a magnetic or optical disk) coupled to processor 234 and memory 235 through an I/O controller 238 and a network interface 239, such as a conventional modem. It will be appreciated from the description below that the present invention may be implemented in software which is stored as executable instructions on a computer readable medium on the client and server systems, such as mass storage devices 227 and 237, respectively, or in memories 225 and 235, respectively.

While the network described with respect to FIGS. 1 and 2 reference a network, and specifically the internet, it will be recognized by one skilled in the art that the network may be any topology, such as private networks (e.g. an intranet) and internal computer structures, that allows either various clients and/or servers within a single computer system to exchange information.

Travel Information Network

FIG. 3 is a pictorial diagram of component systems used in the manner consistent with an exemplary embodiment of the present invention. The components in this exemplary embodiment include the client 102 or 104 of FIG. 1, web server 302, fare watcher server 306, MapQuest server 308, SABRE system 310, and database 312.

Users generate requests, including the flexible set of user-defined criteria, at client(s) 102 and/or 104. Running on client(s) 102 and/or 104 is a web browser 301, and requests are submitted to web server 302 through network 108 of FIG. 1. When it receives a request, the web server 302 submits the request to the fare watcher server 306.

The fare watcher server 306 is responsible for gathering information from the SABRE system 310. The fare watcher server 306 utilizes a request manager 304 for requesting information from the SABRE system 310. The SABRE system 310 is a legacy mainframe database system, which is a conglomerate of different pieces, but is essentially for the purposes of this invention a mainframe where the airline airfares are stored. The airline e-fares are also created from the SABRE system 310.

On a periodic basis, the fare watcher server 306 connects to the SABRE system 310 and searches thousands of city pairs for the current fares (i.e., for the lowest fares between those particular cities), and then stores the fares for those cities in an internal database 312. The cities that are searched are selected from a table of fare watcher email subscribers 314 within database 312. Fare watcher email subscribers are users that register with fare watcher, so that the air fare between selected cities is monitored. Over 100,000 city pairs are monitored for fare watcher subscribers.

Within database 312, other data tables are developed. There is a data table 316 that contains the airport GEO codes, which provide the actual latitude/longitude for where the airport is located. There is a second data table 318 that contains a listing of all of the city pairs that fare watcher subscribers selected, and the lowest available fare that the SABRE system 310 provided for each city pair.

In addition to data tables 316 and 318, a mathematical formula is used to determine an airport that is closest to a city, which a user has selected for departure. The formula uses the longitude/latitude of the departure city selected and data table 316 to determine the airport closest to the city of departure.

After a user enters a request to the web server 302, which includes an airfare threshold amount and other travel related criteria, the request is transferred to an application program 307 running on the fare watcher server 306. The application program 307 performs a query of data table 318, which contains the city pairs selected by the fair watcher subscribers and the lowest fares for those cities, and determines all of the airports that are below the airfare threshold amount.

It may be understood by one skilled in the art that the query executed by the fare watcher server 306 may be implemented by means of a Common Gateway Interface (CGI) 303, which allows the client 102/104 to direct the web server 302 to commence execution of a specified program contained within the fare watcher server 306. This program may include a search engine, which scans the retrieved information in the fare watcher server 306 and transfers this information, via the MapQuest server 308, to the web server 302 for presentation to the user controlling the client 102/104.

It may also be understood by one skilled in the art that based on data table 316, which contains the airport GEO codes and the GEO codes of the airports located, it is possible to query other tables of information created from data stored in database 312. For example, once an airport is located that satisfies the user's request, the airport's GEO code may be used to locate resorts, weather conditions associated with those resorts, and points of interest near the longitude/latitude associated with the airport GEO code.

Once the fare watcher server 306, has retrieved all the requested information, which may include a list of airports with the GEO code, text descriptor, fare amount, and the latitude/longitude associated with each airport, the requested information is transferred to the MapQuest server 308. The MapQuest server 308 then returns an electronic image of a map, locates all the airports on the map, and displays the fares associated with the displayed airports. The MapQuest server 308 basically renders all the information transferred from the fare watcher server 306 onto a map.

After the map is complete, the MapQuest server 308 then transfers the map to the web server 302 for transmission to the user's browser 301 at client 102 and/or 104. At the user's browser 301, the map is displayed for the user with all the requested information.

One skilled in the art will recognize that there is no limitation as to number of servers that the request manager 304 may request information from, or to the amount or type of information that is requested by the request manager 304 and sent to fare watcher server 306 or any similar data storing server. Further, there is no limitation as to how the request manager 304 identifies a particular server or how it determines which inquiry(ies) to send to which server. The only requirement is that each server be identifiable (directly or indirectly) by the request manager 304 and be capable of providing information suitable to function as a response to the inquiry posed by the request manager 304.

One skilled in the art will also recognize that many execution and memory schemes can be used to implement the present invention. In addition, single or multiple computer systems may also be used in the implementation of the present invention. In one embodiment, several components, including the fare watcher server 306 and the MapQuest server 308 are executed and contained within a single computer's memory. This memory may be RAM, ROM, other memory structure or a combination thereof. However, this invention may also be implemented using virtual memory, a secondary storage medium and/or across multiple computers. These various configuration issues relate to an implementation preference and are considered within the scope of the present invention.

Inquiry Paradigm

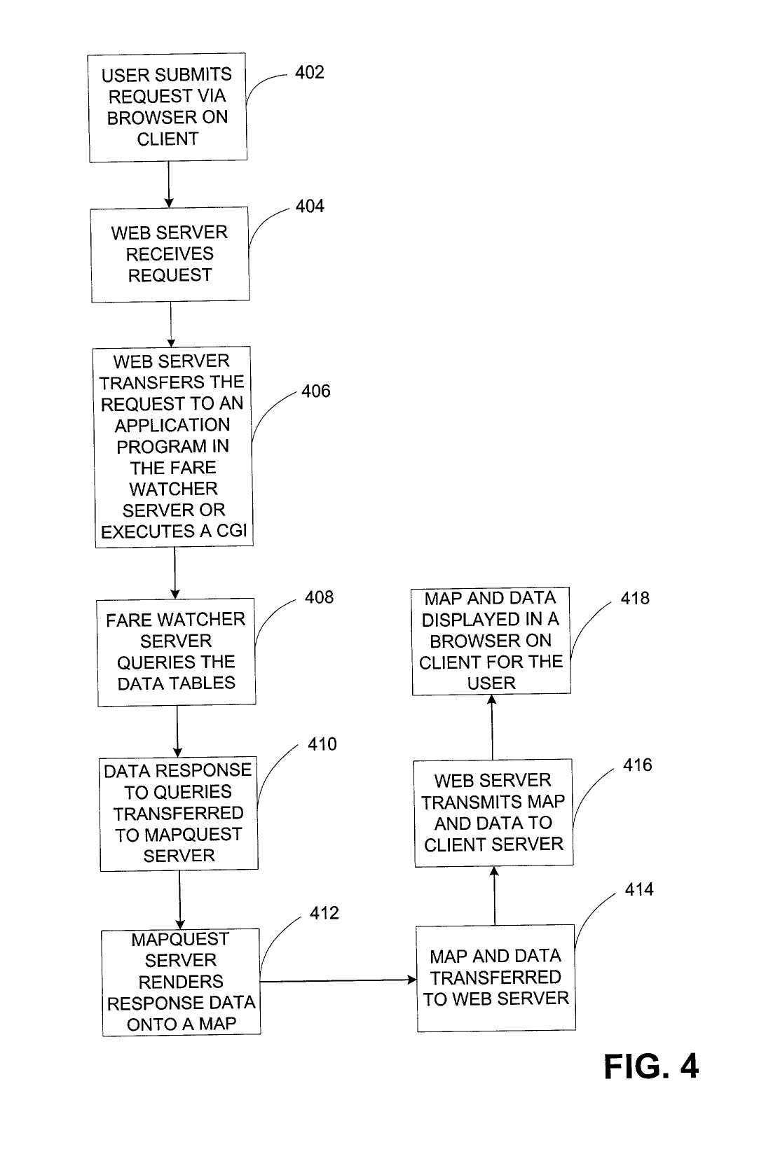

FIG. 4 is a flow chart of the steps performed in response to an inquiry request submitted by a user in a manner consistent with the exemplary embodiment of the present invention. The steps of the flow chart will be described in conjunction with the elements of FIGS. 1 and 3.

In the preferred embodiment of the present invention, the user submits a request, including a flexible set of user-defined criteria, via a browser 301 running on client 102 and/or 104 (Step 402). The user's request is then transmitted, through network 108, and received by the web server 302 (Step 404).

After the web server 302 receives the request, the request is transferred to an application program in the fare watcher server 306 or the web server 302 executes a CGI 303 (Step 406) to query the data tables created from database 312, to formulate a response to the request (Step 408). Once the data response is formulated, the data response to the query is transferred to the MapQuest server 308 (Step 410), where the MapQuest server 308 renders the data response onto an electronic map.

At this point, the map and the data response are transferred to the web server 302 (Step 414). The web server 302 then transmits the map and the data response to the client 102 and/or 104 (Step 416), where the map and the data response are displayed in a browser 301 to the user (Step 418).

Map Display

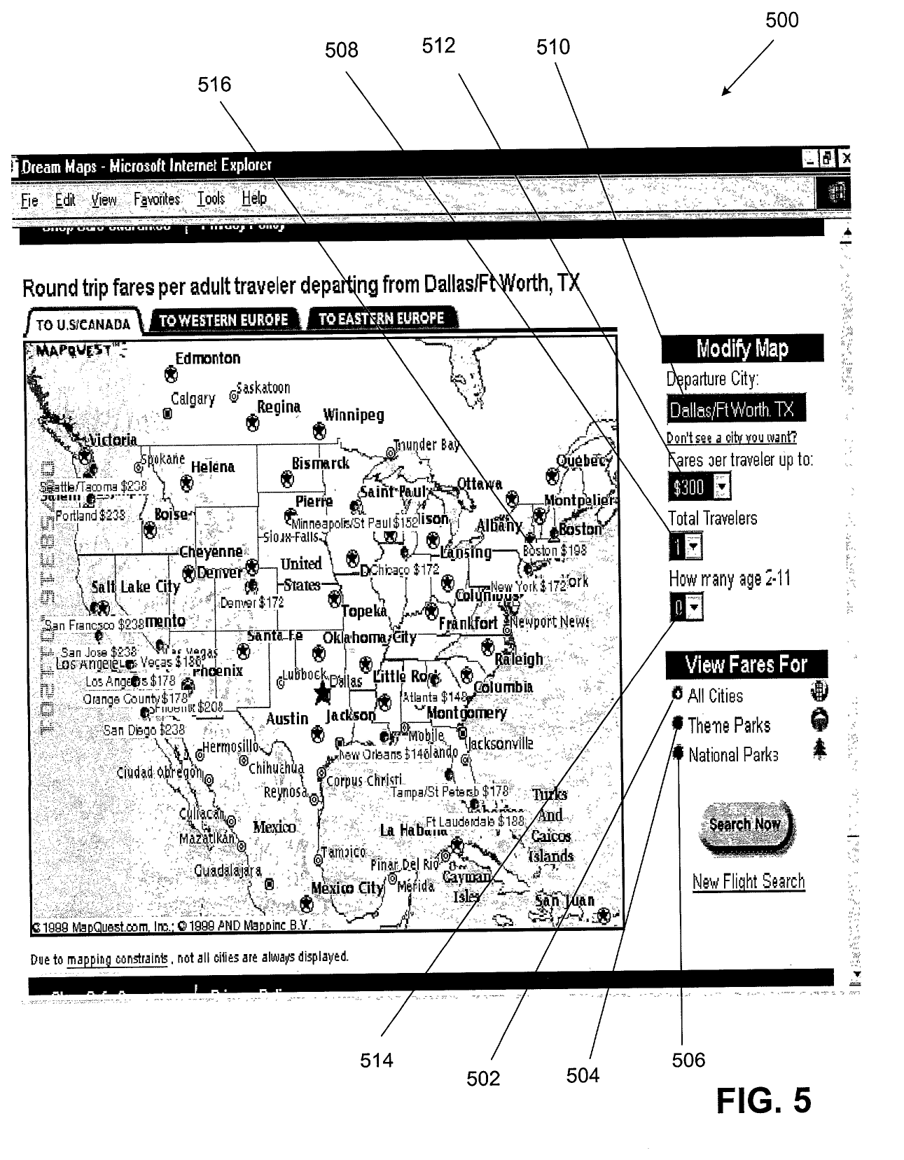

As shown by FIG. 5, the map server provides an electronic map 500 which can serve as an overlay for displaying the requested information. In this exemplary embodiment, the user utilizes click buttons (502, 504, 506) and data boxes (508, 510, 512, 514, 516) to submit the request. The user can view airfare to all cities, theme parks, or national parks. The user utilizes click buttons (502, 504, 506) to select the type of airfares that the user wishes to view. Data boxes (508, 510, 512, 514, 516) are used, respectively, to select the number of travelers, the departure city, the fare threshold value, and the number of children traveling. In this example, the user has specifically requested all the cities that one user can travel to from Dallas/Ft. Worth for under $300.00.

FIG. 5 shows an exemplary map of the United States and Canada, overlaid by information obtained from the queries of the data tables created from database 312 of FIG. 3. The overlaid information includes the destination airport location (by city) and the lowest airfare to the destination airport. For example, the exemplary map shows that to travel from Dallas/Ft. Worth 510 to Boston 516 the cost is $198.00.

One skilled in the art will recognize the advantages of providing user-requested information on a map overlay. Advantages include functional advantages, such as ease of understanding the information, as well as aesthetic advantages.

Conclusion

The present invention comprises a system and methods to distribute travel and other information, and thus facilitates a single reply comprising a map and a solution data set to a user's information request. By providing a network (i.e., a web server, fare watcher server, and MapQuest server), users can receive a single reply to a flexible set of user-defined criteria provided in a single request.

It will be recognized by one skilled in the art that, while this description discusses the invention in terms of airfares, the scope of this invention also includes other travel and non-travel areas including, but not limited to, weather conditions, points of interest, rental cars, hotel rooms, cruise rates, tours, etc.

The foregoing description of an implementation of the invention has been presented for purposes of illustration and description. It is not exhaustive and does not limit the invention to the precise form disclosed. Modifications and variations are possible in light of the above teachings or may be acquired from practicing the invention.

For example, the described implementation includes software but the present invention may be implemented as a combination of hardware and software or in hardware alone. The invention may be implemented with both object-oriented and non-object-oriented programming systems. Additionally, components of the present invention are stored in memory; one skilled in the art will appreciate that these components can be stored on other types of computer-readable media, such as secondary storage devices, like hard disks, floppy disks, or CD-ROM; a carrier wave from the Internet or other propagation medium; or other forms of RAM or ROM. The scope of the invention is defined by the claims and their equivalents.

What is claimed is:

1. A method for graphically displaying travel information on an electronic map within a network environment, the method comprising the steps of:
receiving an information request based on a flexible set of user-defined travel related criteria from a client;
processing the information request to initiate at least one inquiry based on the information request and receiving at least one information response to the at least one inquiry from a server; and
rendering the at least one information response unto an electronic map overlay for transmission to a client.

2. The method of claim 1, wherein the information providers are servers or mainframe computer systems.

3. The method of claim 1, wherein the flexible set of user-defined travel related criteria is input by a human being on a client and pre-selected at least in part by topic by the client.

4. The method of claim 1, wherein processing the information request includes parsing the information request into a plurality of inquiries for querying a plurality of data tables.

5. The method of claim 1, wherein the at least one inquiry is directed to a plurality of data tables generated from a database of information received from at least one of a plurality of information providers.

6. The method of claim 5, wherein processing the at least one information response to the at least one inquiry further comprises collecting a plurality of responses to determine a solution set to the information request.

7. The method of claim 1, wherein transmitting the information response includes directing the response to the user that posed the information request.

8. A system for distributing travel information in a network, the system comprising:
means for providing a travel information request;
means for processing the travel information request to generate an inquiry;
means for receiving a response to the inquiry; and
means for processing the response to obtain a reply to the travel information request.

9. A travel information system, comprising:
a request manager for receiving information from information providers to store in a database;
an information request that is processed to initiate at least one inquiry related to the information from the database;
a plurality of data tables developed from the database for providing information responsive to the at least one inquiry and providing a solution set to the information request; and
an electronic map upon which the solution set is overlaid.

10. The travel information system of claim 9, wherein at least one inquiry is directed to a data table selected from a group of data tables containing airfare, airfare availability, weather conditions, event schedules, points of interest, and lodging information.

11. The system of claim 9, wherein the information providers are servers or mainframe computer systems.

12. The system of claim 9, wherein the information request is input by a human being on a client computer and is pre-selected at least in part by topic by the client.

13. The system of claim 9, wherein processing the information request includes parsing the information request into a plurality of inquiries for querying a plurality of data tables.

14. The system of claim 9, wherein the information request is directed to a plurality of data tables generated from a database of information received from the information providers.

15. The system of claim 9, wherein processing information responsive to the information request further comprises collecting a plurality of responses to determine a solution set to the information request.

16. A method for providing travel information, comprising:
receiving a request including a departure location;
location generating a map including a set of points corresponding to the departure location and any airports having carrier service from the departure location to another location; and
transmitting the generated map.

17. The method of claim 16, wherein the step of receiving the request includes specifying a location of interest and a distance range in proximity to the location of interest.

18. The method of claim 16, wherein the step of receiving the request includes specifying a dollar limit.

19. The method of claim 18, wherein the step of receiving the request includes specifying a number of travelers that will depart from the departure location.

20. The method of claim 16, wherein the generating step includes accessing a database for a geocode corresponding to a destination of interest.

21. The method of claim 20, wherein the generating step includes accessing a database for a plurality of city pairs and a lowest available fare associated with each of the plurality of city pairs.

22. The method of claim 20, wherein the generating step includes querying the database with the geocode corresponding to a destination of interest to determine all airports and other locations within a specified range of the geocode.

23. The method of claim 16, wherein the generating step includes retrieving information from information providers and storing the retrieved information in a searchable database.

24. A method for a user to obtain travel information, comprising:
entering a request including a departure location; and
receiving a map generated to include a set of points corresponding to the departure location and any airports having carrier service from the departure location to another location.

25. The method of claim 24, wherein the step of entering the request includes specifying a dollar limit.

26. The method of claim 25, wherein the step of entering the request includes specifying a number of travelers that will depart from the departure location.

27. The method of claim 24, wherein the step of entering the request includes specifying a location of interest and a specified distance range in proximity to the location of interest.
